(19) United States
(12) Patent Application Publication
(10) Pub. No.: US 2025/0033876 A1
(43) Pub. Date: Jan. 30, 2025

(54) SYSTEMS AND METHODS FOR PROCESSING OBJECTS INCLUDING MOBILE MATRIX CARRIER SYSTEMS

(71) Applicant: Berkshire Grey Operating Company, Inc, Bedford, MA (US)

(72) Inventors: Thomas WAGNER, Concord, MA (US); Kevin AHEARN, Nebo, NC (US); John Richard AMEND, Belmont, MA (US); Benjamin COHEN, Somerville, MA (US); Michael DAWSON_HAGGERTY, Pittsburgh, PA (US); William Hartman FORT, Stratham, NH (US); Christopher GEYER, Arlington, MA (US); Jennifer Eileen KING, Oakmont, PA (US); Thomas KOLETSCHKA, Cambridge, MA (US); Michael Cap KOVAL, Mountain View, CA (US); Kyle Maroney, North Attleboro, MA (US); Matthew T. MASON, Pittsburgh, PA (US); William Chu-Hyon MCMAHAN, Cambridge, MA (US); Gene Temple PRICE, Cambridge, MA (US); Joseph ROMANO, Arlington, MA (US); Daniel Carlton SMITH, Canonsburg, PA (US); Siddhartha SRINIVASA, Seattle, WA (US); Prasanna VELAGAPUDI, Pittsburgh, PA (US); Thomas ALLEN, Reading, MA (US)

(21) Appl. No.: 18/908,655

(22) Filed: Oct. 7, 2024

Related U.S. Application Data
(63) Continuation of application No. 18/368,585, filed on Sep. 15, 2023, now Pat. No. 12,145,798.
Application No. 18/368,585 is a continuation of application No. 17/832,484, filed on Jun. 3, 2022, now Pat. No. 11,814,245.
Application No. 17/832,484 is a continuation of application No. 16/993,364, filed on Aug. 14, 2020, now Pat. No. 11,390,459.
Application No. 16/993,364 is a continuation of application No. 15/926,497, filed on Mar. 20, 2018, now Pat. No. 10,807,795.
(60) Provisional application No. 62/578,030, filed on Oct. 27, 2017.
(60) Provisional application No. 62/473,790, filed on Mar. 20, 2017.

(51) Int. Cl. B65G 1/02; B65G 1/04; B65G 1/137; B65G 65/00

(52) U.S. Cl. CPC B65G 1/02; B65G 1/0492; B65G 1/1378; B65G 65/005; B65G 2209/04

(57) ABSTRACT

A storage, retrieval and processing system for processing objects is disclosed. The storage, retrieval and processing system includes a plurality of storage bins providing storage of a plurality of objects, where the plurality of storage bins is in communication with a bin conveyance system for moving selected storage bins to a storage bin processing location, a programmable motion device in communication with the bin processing location for receiving a selected storage bin from the plurality of bins, where the programmable motion device includes an end effector for grasping and moving a selected object out of a selected storage bin, and a plurality of destination bins in communication with the bin conveyance system for moving a selected destination bin from a destination bin processing location that is proximate the programmable motion device to the plurality of destination bins.

### PRIORITY

The present application is a continuation of U.S. patent application Ser. No. 18/368,585, filed Sep. 15, 2023, which is a continuation of U.S. patent application Ser. No. 17/832,484, filed Jun. 3, 2022, now U.S. Pat. No. 11,814,245, issued Nov. 14, 2023; which is a continuation of U.S. patent application Ser. No. 16/993,364, filed Aug. 14, 2020, now U.S. Pat. No. 11,309,459, issued Jul. 19, 2022; which is a continuation of U.S. patent application Ser. No. 15/926,497, filed Mar. 20, 2018, now U.S. Pat. No. 10,807,975, which claims priority to U.S. Provisional Patent Application Ser. No. 62/473,790 filed Mar. 20, 2017 as well as U.S. Provisional Patent Application Ser. No. 62/578,030 filed Oct. 27, 2017, the disclosures of both of which are hereby incorporated by reference in their entireties.

### BACKGROUND

The invention generally relates to object processing systems, and relates in particular to automated storage and retrieval systems that are used with systems for processing objects.

Automated storage and retrieval systems (AS/RS) generally include computer controlled systems for automatically storing (placing) and retrieving items from defined storage locations. Traditional AS/RS typically employ totes (or bins), which are the smallest unit of load for the system. In these systems, the totes are brought to people who pick individual items out of the totes. When a person has picked the required number of items out of the tote, the tote is then re-inducted back into the AS/RS.

In these traditional systems, the totes are brought to a person, and the person may either remove an item from the tote or add an item to the tote. The tote is then returned to the storage location. Such systems, for example, may be used in libraries and warehouse storage facilities. The AS/RS involves no processing of the items in the tote, as a person processes the objects when the tote is brought to the person. This separation of jobs allows any automated transport system to do what it is good at—moving totes—and the person to do what the person is better at—picking items out of cluttered totes. It also means the person may stand in one place while the transport system brings the person totes, which increases the rate at which the person can pick goods.

There are limits however, on such conventional systems in terms of the time and resources required to move totes toward and then away from each person, as well as how quickly a person can process totes in this fashion in applications where each person may be required to process a large number of totes. There remains a need therefore, for an AS/RS that stores and retrieves objects more efficiently and cost effectively, yet also assists in the processing of a wide variety of objects.

### SUMMARY

In accordance with an embodiment, the invention provides a storage, retrieval and processing system for processing objects. The storage, retrieval and processing system includes a plurality of storage bins providing storage of a plurality of objects, where the plurality of storage bins is in communication with a bin conveyance system for moving selected storage bins to a storage bin processing location, a programmable motion device in communication with the bin processing location for receiving a selected storage bin from the plurality of bins, where the programmable motion device includes an end effector for grasping and moving a selected object out of a selected storage bin, and a plurality of destination bins in communication with the bin conveyance system for moving a selected destination bin from a destination bin processing location that is proximate the programmable motion device to the plurality of destination bins.

In accordance with another embodiment, the invention provides a storage, retrieval and processing system for processing objects including a plurality of storage bins providing storage of a plurality of objects, where the plurality of storage bins is in communication with a storage bin conveyance system for moving selected storage bins to a storage bin processing location, a programmable motion device in communication with the storage bin processing location for receiving a selected storage bin from the plurality of bins, where the programmable motion device includes an end effector for grasping and moving a selected object out of a selected storage bin, and a plurality of destination bins in communication with the conveyance system for moving a selected destination bin from a destination bin processing location that is proximate the programmable motion device to the plurality of destination bins.

In accordance with a further embodiment, the invention provides a method of providing storage, retrieval and processing of objects. The method includes the steps of providing a plurality of storage bins for storage of a plurality of objects, moving a selected storage bin to a storage bin processing location using a storage bin conveyance system, receiving the selected storage bin, grasping and moving a selected object out of the selected storage bin to selected destination bin, and moving the selected destination bin from a destination bin processing location that is proximate the programmable motion device to a plurality of destination bins.

### BRIEF DESCRIPTION OF THE DRAWINGS

The following description may be further understood with reference to the accompanying drawings in which:

FIG. 1 shows an illustrative diagrammatic view of a storage, retrieval and processing system in accordance with an embodiment of the present invention;

FIG. 2 shows an illustrative diagrammatic view of a portion of the storage, retrieval and processing system of FIG. 1;

FIG. 3 shows an illustrative diagrammatic view of a larger portion of the storage, retrieval and processing system of FIG. 1;

FIG. 4 shows an illustrative diagrammatic view of a carrier and bin in a storage, retrieval and processing system of FIG. 1;

FIGS. 5A and 5B show illustrative diagrammatic isometric views of the carrier of FIG. 18 with the wheel assemblies in each of two different pivotal positions;

FIGS. 6A and 6B show illustrative diagrammatic side views of the carrier shown in FIGS. 5A and 5B taken along lines 6A-6A and 6B-6B respectively;

FIGS. 7A and 7B show illustrative diagrammatic end views of the carrier shown in FIGS. 5A and 5B taken along lines 7A-7A and 7B-7B respectively;

FIGS. 8A and 8B show illustrative diagrammatic bottom views of the carrier shown in FIGS. 5A and 5B respectively;

FIGS. 9A and 9B show illustrative diagrammatic views of pivotal wheel assemblies for use in a carrier of an embodiment of the present invention in each of two positions;

FIGS. 10A and 10B show illustrative diagrammatic bottom views of the carrier shown in FIGS. 8A and 8B respectively with track sections superimposed thereon for illustrative purposes;

FIGS. 11A-11C show illustrative diagrammatic views of the carrier of FIG. 4 at different stages of engaging an adjacent track section during movement;

FIG. 12 shows an illustrative diagrammatic view of guide rollers of the carrier of FIG. 4 engaging a track section;

FIG. 13 shows an illustrative diagrammatic isometric view of a carrier engaging a bin with a rack in accordance with an embodiment of the present invention;

FIG. 14 shows an illustrative diagrammatic top view of the carrier, bin and rack of FIG. 13;

FIG. 15 shows an illustrative diagrammatic side view of the carrier, bin and rack of FIG. 13;

FIGS. 16A and 16B show illustrative diagrammatic side views of a carrier placing the bin onto the rack (FIG. 16A), and a carrier removing a bin from a rack (FIG. 16B);

FIG. 17 shows an illustrative diagrammatic view of a carrier for use in a system in accordance with another embodiment of the present invention;

FIG. 18 shows an illustrative diagrammatic top view of the carrier shown in FIG. 17;

FIG. 19 shows an illustrative diagrammatic view of a carrier for use in a system in accordance with a further embodiment of the present invention;

FIG. 20 shows an illustrative diagrammatic top view of the carrier shown in FIG. 19;

FIG. 21 shows an illustrative diagrammatic bottom view of the carrier shown in FIG. 19;

FIG. 22 shows an illustrative diagrammatic view of the bin processing system of FIG. 1;

FIG. 23 shows an illustrative diagrammatic view from the perception system of FIG. 22, showing a view of objects within a bin of objects to be processed;

FIGS. 24A and 24B show an illustrative diagrammatic view of a grasp selection process in a storage, retrieval and processing system of an embodiment of the present invention;

FIGS. 25A and 25B show an illustrative diagrammatic view of a grasp planning process in a storage, retrieval and processing system of an embodiment of the present invention;

FIGS. 26A and 26B show an illustrative diagrammatic view of a grasp execution process in a storage, retrieval and processing system of an embodiment of the present invention;

FIG. 27 shows an illustrative diagrammatic view of a storage, retrieval and processing system in accordance with another embodiment of the present invention involving multiple levels of track systems; and

FIG. 28 shows an illustrative diagrammatic view of a storage, retrieval and processing system in accordance with a further embodiment of the present invention involving a large number of levels of track systems.

The drawings are shown for illustrative purposes only.

### DETAILED DESCRIPTION

In accordance with an embodiment, the invention provides a storage, retrieval and processing system for processing objects. The system includes a plurality of storage bins, a plurality of destination bins, and a programmable motion device. The plurality of storage bins provide storage of a plurality of objects and are in communication with a bin conveyance system for moving selected storage bins to a storage bin processing location. The programmable motion device is in communication with the bin processing location for receiving a selected storage bin from the plurality of bins. The programmable motion device includes an end effector for grasping and moving a selected object out of a selected storage bin. The plurality of destination bins is in communication with the bin conveyance system for moving a selected destination bin from the plurality of bins to a destination bin processing location that is proximate the programmable motion device.

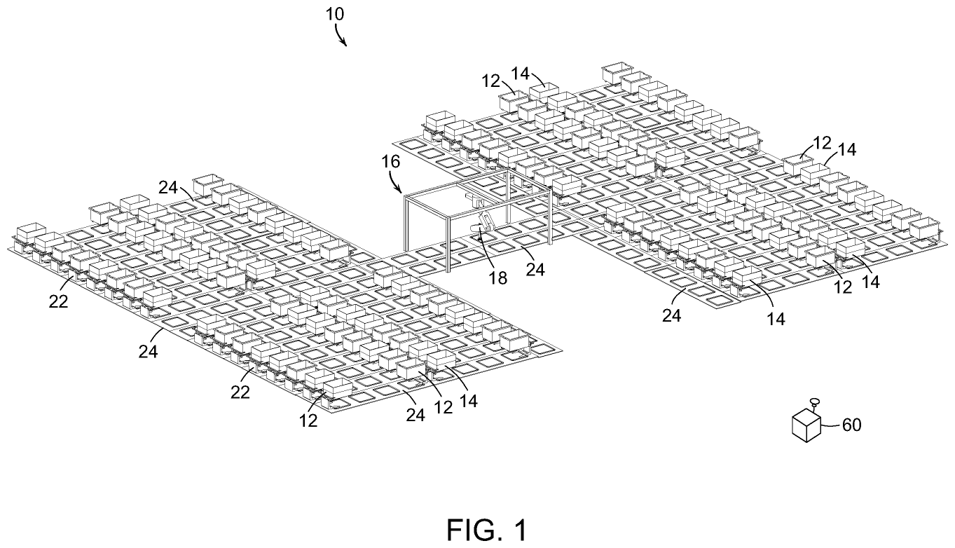

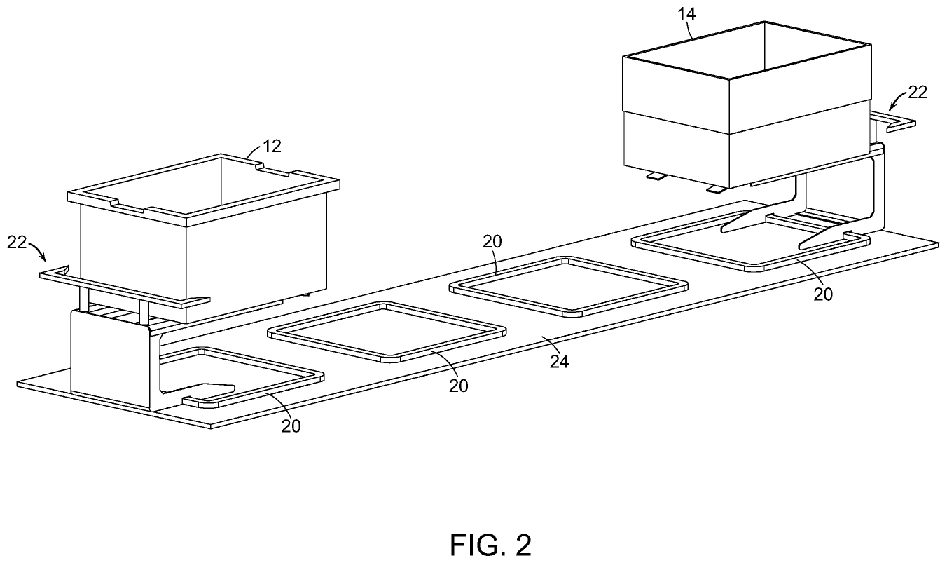

With reference to FIG. 1, a system 10 of an embodiment of the present invention includes a plurality of storage bins 12, a plurality of destination bins 14, and a bin processing section 16 that includes a programmable motion device 18. The bins 12, 14 may be stored on racks 22, and are movable about the system 10 on carriers (discussed below) that run on track sections 24. With further reference to FIG. 2, the bins 12, 14 may be located on shelves 22 that are positioned on the track sections 24, and the track sections may include a plurality of discontinuous tracks 20.

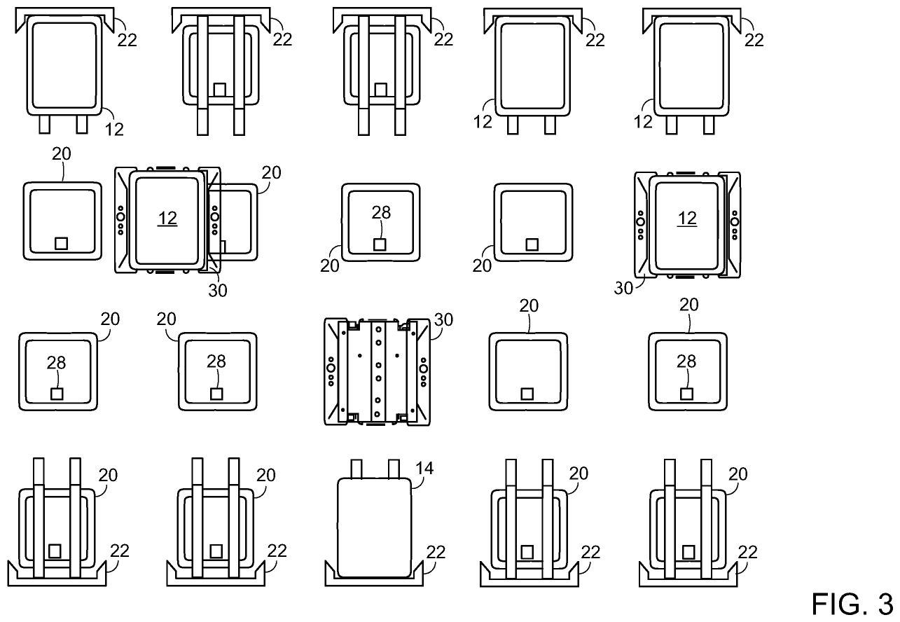

With further reference to FIG. 3, each of the storage bins 12 and destination bins 14 may be transferred to and from mobile carriers 30 for movement about the tracks 20. In accordance with an embodiment, the mobile carriers may include swivel mounted wheels that rotate ninety degrees to cause each mobile carrier to move either forward and backward, or side to side. When placed on a grid, such mobile carriers may be actuated to move to all points on the grid.

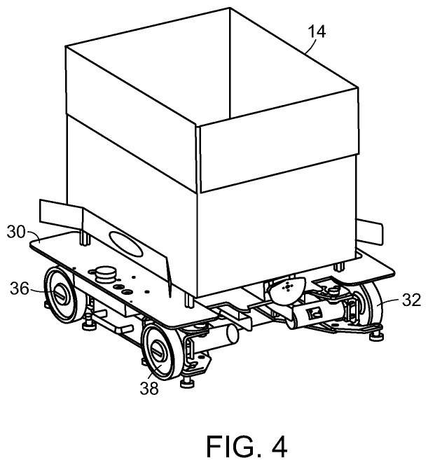

FIG. 3 shows a portion of a system that is formed of multiple track sections (one track section is shown in FIG. 2), and each track section includes a plurality of tracks 20. The system also includes one or more mobile carrier units 30 that carry a bin 12, 14 as shown in FIG. 4. Each track 20 is generally in the form of a raised square with rounded edges, and the tracks 20 are generally closed spaced from each other (e.g., within a length or width of a mobile carrier unit 30). With reference to FIG. 4, each mobile carrier unit 30 may support a bin 12, 14 that may contain objects to be processed or that have been processed. A computer processor 60 may control the movement of each carrier unit 30 by wireless communication. The tracks 20 may also include sensors (as discussed further below) for detecting when each carrier unit 30 is positioned above each individual track 20.

Each mobile carrier unit 30 includes a pair of guide rails 42, 44 that contain the bin 12, 14, as well as a raised region 46 that raises the bin sufficient for there to be room on either side of the raised region for shelf forks to engage the bin as will be further discussed below. Each carrier unit 30 also includes four wheel assemblies 32, 34, 36, 38 that each include guides 40 for following the tracks 20. Each of the wheel assemblies is pivotally mounted such that each wheel assembly may pivot 90 degrees as discussed below. Each carrier unit 30 also includes a pair of paddles 48, 50 on either end of the unit 30. Each paddle may be turned either upward to contain a bin on the unit, or turned downward to permit a bin to be loaded onto or removed from the unit as will also be discussed in more detail below.

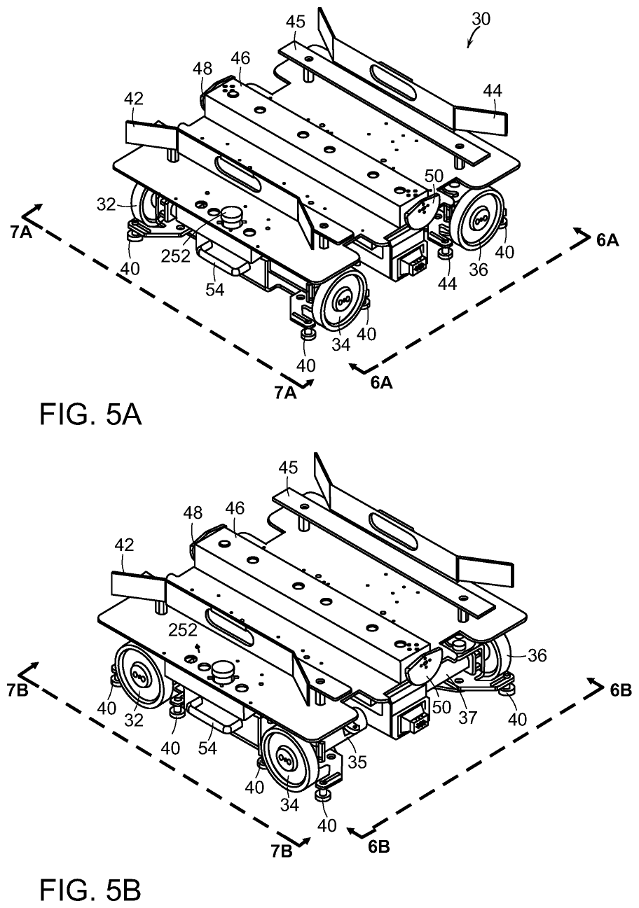

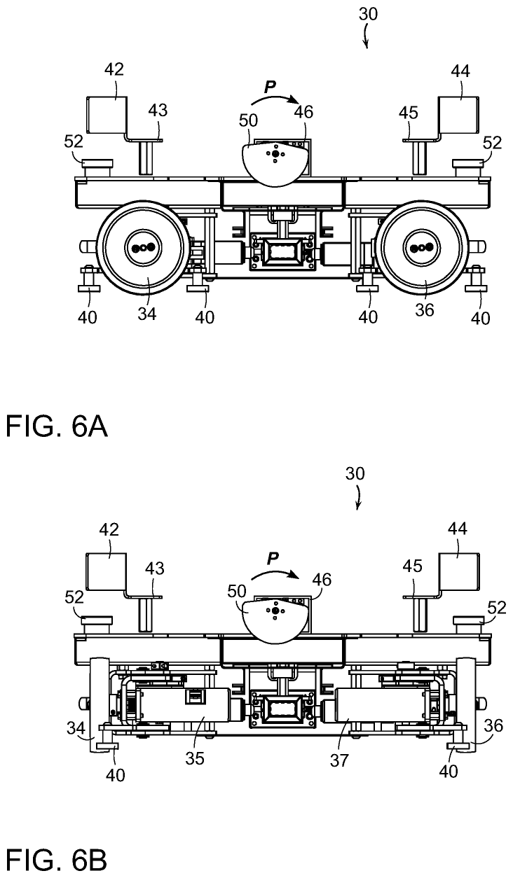

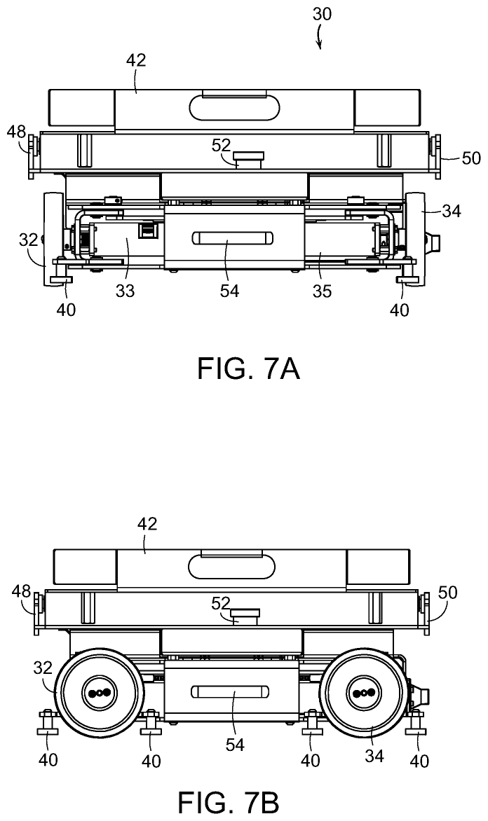

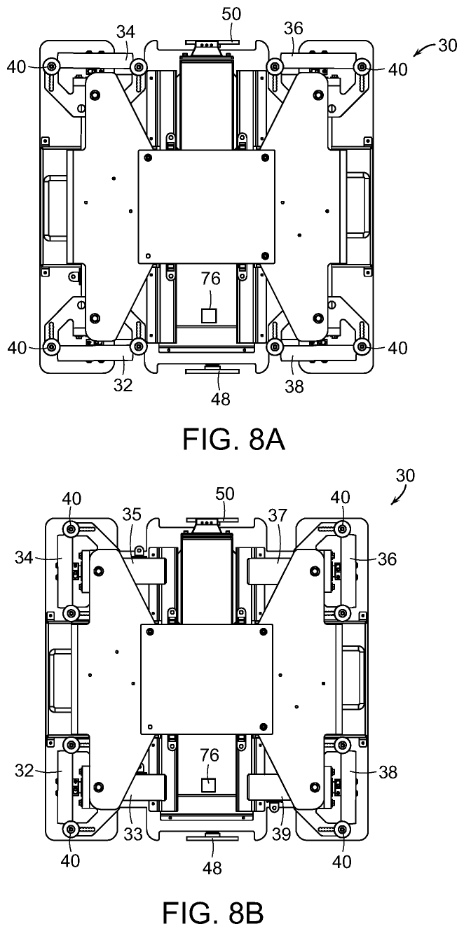

In accordance with certain embodiments therefore, the invention provides a plurality of mobile carriers that may include swivel mounted wheels that rotate ninety degrees to cause each mobile carrier to move forward and backward, or to move side to side. When placed on a grid, such mobile carriers may be actuated to move to all points on the grid. FIGS. 5A and 5B, for example, show a mobile carrier 30 that includes wheels 32, 34, 36 and 38 (shown in FIGS. 8A and 8B). Each of the wheels is mounted on a motor 33, 35, 37, 39 (as best shown in FIG. 8B), and the wheel and motor units (wheel assemblies) are pivotally mounted to the carrier 30 as discussed in more detail below. The wheel assemblies (each including a wheel, its motor and track guides 40) are shown in one position in FIG. 5A, and are shown in a second pivoted position in FIG. 5B. FIG. 6A shows an end view of the carrier 30 taken along lines 6A-6A of FIG. 5A, and FIG. 6B shows an end view of the carrier 30 taken along lines 6B-6B of FIG. 5B. Similarly, FIG. 7A shows a side view of the carrier 30 taken along lines 7A-7A of FIG. 5A, and FIG. 7B shows a side view of the carrier 30 taken along lines 7B-7B of FIG. 5B.

Each carrier 30 also includes a pair of opposing rails 42, 44 for retaining a bin, as well as a raised center portion 46 and stands 43, 45 on which a bin may rest. A pair of independently actuated paddles 48, 50 are also provided. Each paddle 48, 50 may be rotated upward (as shown at P in FIG. 6A) to retain a bin on the carrier, or may be rotated downward to permit a bin to be moved onto or off of a carrier. The paddles 48, 50 are shown rotated downward in FIGS. 5A-7B.

Note that the orientation of the carrier 30 (also a bin on the carrier) does not change when the carrier changes direction. Again, a bin may be provided on the top side of the carrier, and may be contained by bin rails 42, 44 on the sides, as well actuatable paddles 48, 50. As will be discussed in further detail below, each paddle 48, 50 may be rotated 180 degrees to either urge a bin onto or off of a shelf, or (if both are actuated) to retain a bin on the carrier during transport. Each paddle may therefore be used in concert with movement of the carrier to control movement of the bin with respect to the carrier 30. For example, when on paddle is flipped into an upward position, it may be used to urge the bin onto a shelf or rack while the carrier is moving toward the shelf or rack. Each carrier may also include one or more emergency stop switches 52 for a person to use to stop the movement of a carrier in an emergency, as well as handles 54 to enable a person to lift the carrier if needed.

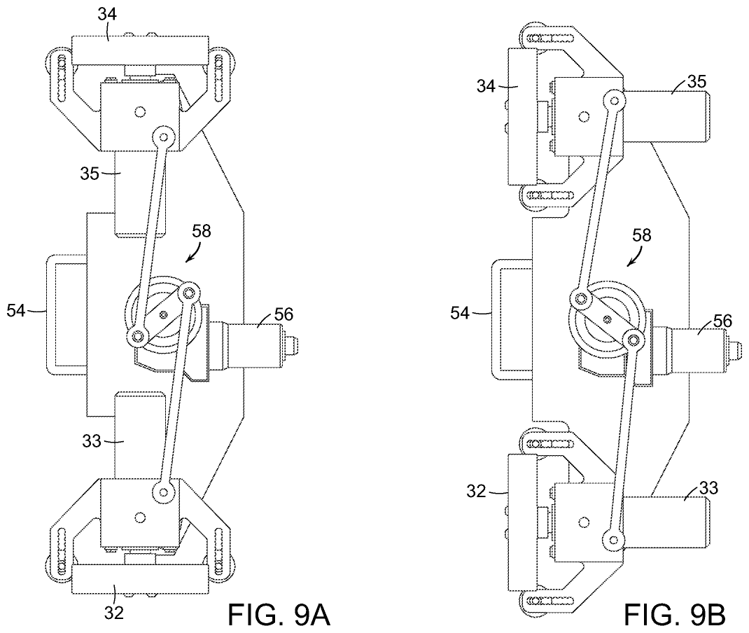

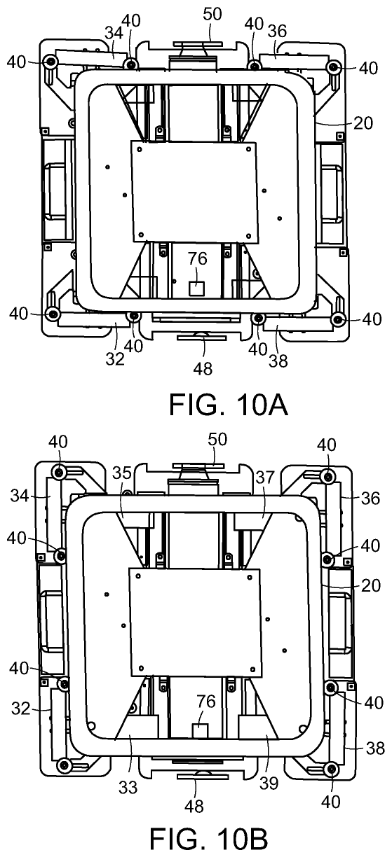

FIG. 8A shows a bottom view of the carrier 30 with the wheels in the position as shown in FIG. 5A, and FIG. 8B shows a bottom view of the carrier 30 with the wheels in the position as shown in FIG. 5B. FIGS. 8A and 8B show all of the wheels 32, 34, 36 and 38, and each of the motors 33, 35, 37 and 38 is also shown in FIG. 8B. As may be seen in FIGS. 8A and 8B, the entire wheel assemblies including the wheel, guide rollers and the wheel motor, each pivot as a unit. With reference to FIGS. 9A and 9B, each pair of wheel assemblies may, in an embodiment, be pivoted by a common pivot motor 56 that is coupled to the wheel assemblies via linkages 58. FIG. 9A shows a pair of wheel assemblies in a position as shown in FIG. 5A, and FIG. 9B shows the pair of wheel assemblies in a position as shown in FIG. 5B. The wheel assemblies are designed to be able to pivot the wheels around corners of a track section when the carrier is directly above a track section. FIGS. 10A and 10B show views similar to the underside views of FIGS. 8A and 8B but with a track 20 superimposed on the Figures to show the relation of the wheel positions to the track section. Note that the wheels pivot around each of the corners of the track section. When the carrier is centered over the track section, therefore, the wheels may be pivoted such that the carrier may move in a direction that is orthogonal to a prior direction without requiring that the carrier itself be turned. The orientation of the carrier is therefore maintained constant while the carrier is moved about an array of track sections.

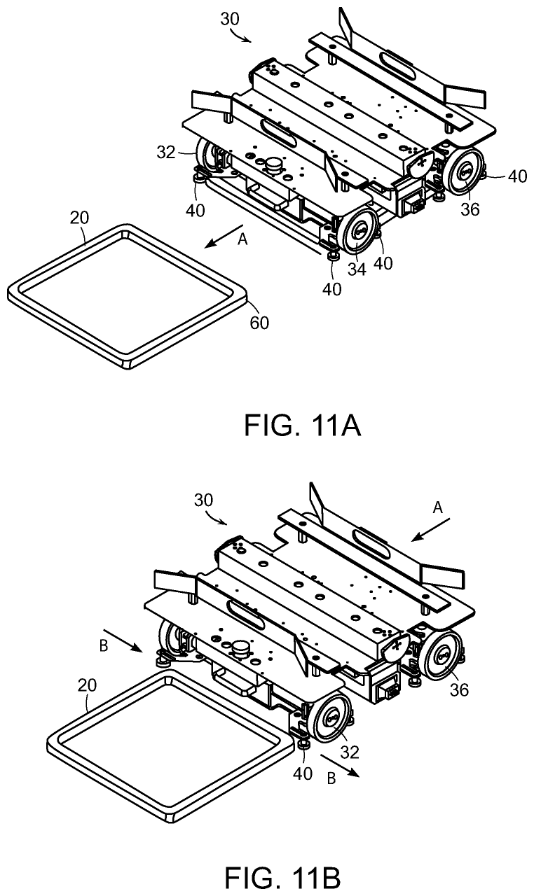

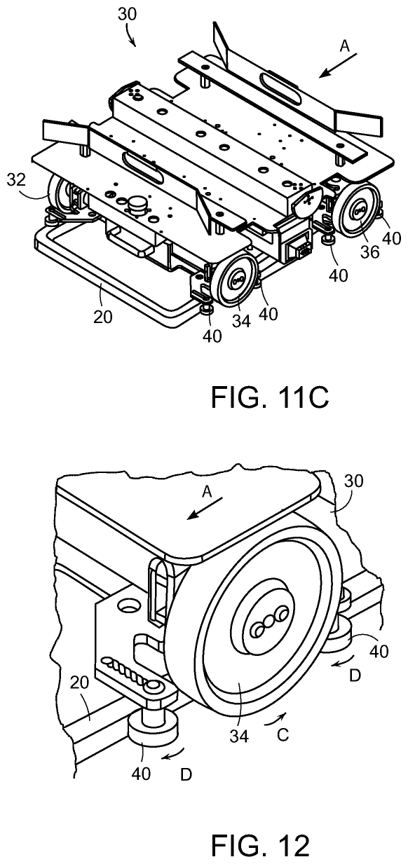

The movement of the carrier 30 about an array of tracks is further discussed below with regard to FIGS. 11A-11C. In short as a carrier leaves one track, it travels toward an adjacent track, and if at all misaligned, will realign itself. The realignment of the guide rollers and the tracks may function as follows. While the two sets of wheels (32, 34 and 36, 38) may be designed to move the carrier 30 in a linear direction only, some variations may occur. The tracks 20 are positioned, though intermittently, close enough to each other than when a carrier leaves one track and moves toward another 20 (as shown at A), its potential variation off course will be small enough that the rounded corners of the next adjacent track will urge the carrier back on course. For example, FIG. 11A shows a carrier 30 leaving a track and beginning to approach a next track 20 as the carrier moves in a direction as indicated at A. As shown in FIG. 11B, if the alignment of the carrier 30 is off (possibly from variations in the wheels or the mounting of the wheels, the placement of the track sections or any other variable), one of the rounded corners 60 of next adjacent track 12 will become engaged by an on-coming guide wheel 40, and the rounded corner 60 will cause the carrier 30 to move slightly in a direction (as shown at B) perpendicular to the direction A to correct the direction of movement of the carrier 30. If a carrier does stop moving, the directions of movement of the other carriers are programmed to avoid the area of the stopped carrier until it is removed. If an area results in a number of stopped carriers over time, the alignment of the track(s) in the area may be examined and/or replaced.

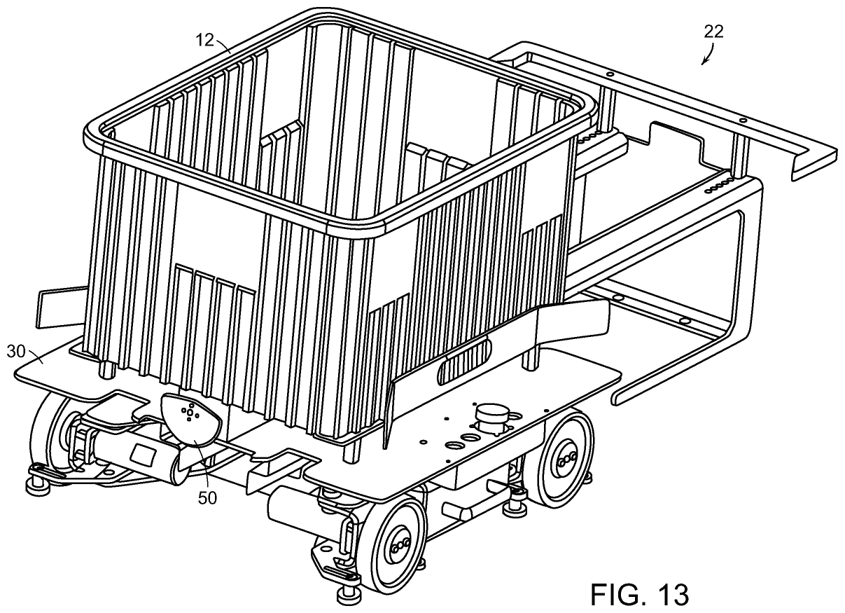

FIG. 11C shows the carrier 30 moving in a direction A as properly realigned by the track 20. FIG. 12 shows a close up view of the wheel 34 moving in a direction as shown at C to cause the carrier to move in the direction A, and further shows that the guide rollers 40 roll against the track 20 in directions as shown at I). The guide rollers 400 do not touch the ground (as does the wheel 34), but simply guide the direction of the carrier 30 by being urged against the track 20. In further embodiments, biasing means such as springs, elastics or pneumatics may be used to urge the guide rollers against the track, and in further embodiments, the tracks may be more triangular shaped at the edges to further facilitate reception of the carriers. If too much correction is required, however, the system may be operating inefficiently.

Systems of the invention therefore provide for binary steering of the automated carrier, allowing only bidirectional column and row travel in a grid. One pivot motor may be used for each pair of wheels, with a linkage to pivot the wheel modules. On other embodiments, one pivot motor and linkage could be used for all four wheels, or each wheel may have an independent pivot actuator. The system allows the wheels to follow square track sections by pivoting around rounded corners of the square track sections. The system does not require differential drive line/trajectory following, and keeps the orientation of the carrier fixed throughout all operations.

The bin shelf and retrieval system provides that bins (e.g., totes or boxes etc.) are carried by a carrier, which has a bin storage area that includes a center rail, two side rails, and a motorized paddle on the front and back of the tote. When the bin is being driven around, both paddles are up and the bin is fully contained. To store a bin, the robot drives into a bin rack, which consists of two fork tines with an incline on the front, and the incline urges the bin above the rail height on the robot. The paddles are put down and the robot can drive away with the bin left behind on the rack. To retrieve a bin, the robot drives under the shelf, puts its paddles up, and drives away.

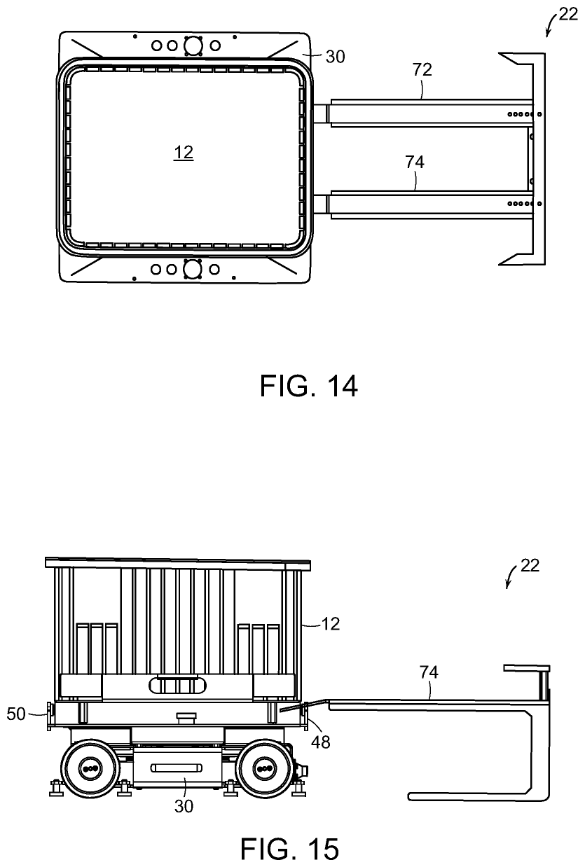

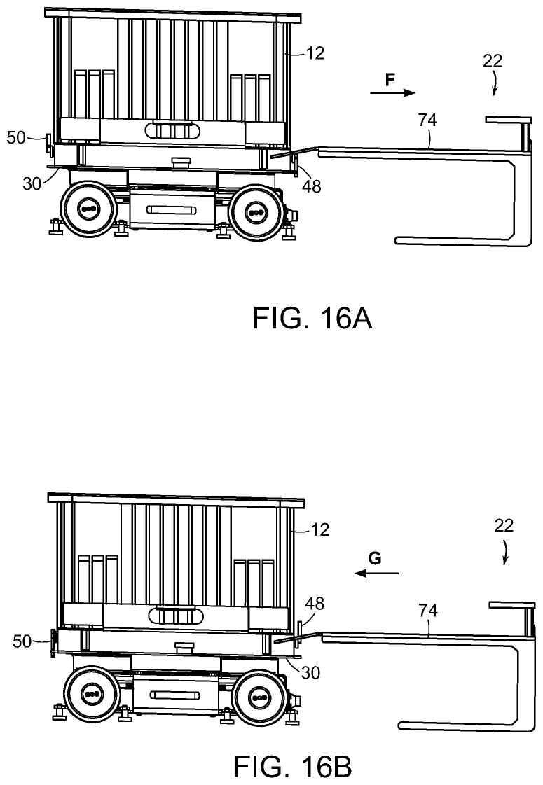

FIGS. 13-16B show the carrier 30 with the paddles 48, 50 in different configurations for moving bins 12, 14 onto and off of racks 22. FIG. 16A shows a side view of the carrier 30 with the paddle 50 engaged to urge the bin 16 onto the rack 22, and FIG. 16B shows a side view of the carrier 30 with the paddle 48 engaged to urge the bin 16 off of the rack 22. FIG. 16A shows the carrier 30 with the paddle 50 up such that the bin 16 on the carrier 30 may be moved onto a fixed rack 22 that includes two forks 72, 74. In particular, the forks 72, 74 have ramped ends that engage the carrier 30 between the underside of the bin 12, 14 and on either side of the raised center portion 46. To remove the bin 30 from the rack 22, the carrier 30 is driven under the rack, and the opposite paddle 48 is actuated. When the carrier is moved away from the rack, the paddle 48 urges the bin 12, 14 onto the carrier 30 as the carrier is driven away from the rack. FIG. 16B, for example, shows the carrier 30 with the paddle 48 activated (as shown in FIG. 2) such that as the carrier 30 is moved away from the rack 22, the paddle 48 urges the bin 12, 14 onto the carrier 30.

As mentioned above, the track system may be formed of disconnected tracks. With reference again to FIG. 3, a portion of a track system is shown that includes a plurality of tracks 20, as well as racks 22. The guide rollers discussed above are positioned to roll against the outside of the tracks 20, and since the carriers generally travel in straight lines (either forward
backward or side-to side), the guide rollers are designed to engage the intermittent tracks and realign themselves due to each track having slightly rounded corners. Each intermittent track may also include a location code 28 (e.g., a QR code) that permits the carrier to register its location with the central controller 60. The carrier may include a detector 76 (such as a camera or a scanner) on the underside thereof as shown in FIGS. 8A, 8B and 10A, 10B that reads or detects each location code 28. Again, the orientation of each carrier does not change. In the system of FIG. 3, numerous discontinuous tracks 20 are shown, together with carriers 30. In particular, one carrier has left a bin 14 on rack 22 and has been given an instruction to move one track section to the North. Another carrier carrying bin 12 has been given an instruction to move one track section to the West, and another carrier is carrying bin 12. The system 60 moves each of the carriers in the tracks to avoid each other and to provide desired bins at appropriate shelves or racks. As noted, each carrier is provided an instruction to move only one or two track sections at a time. The system 60 is in constant communication with all of the carriers. In certain embodiments, the system provides a wireless heartbeat chain that provides bidirectional heartbeat between mobile carriers and fixed computing infrastructure. If a heartbeat isn't received by a mobile carrier, it triggers an emergency stop, and if a heartbeat isn't received by the processing system 60, it triggers an appropriate response.

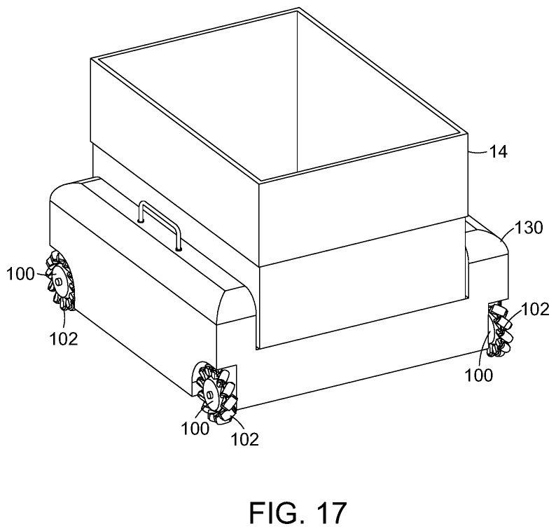

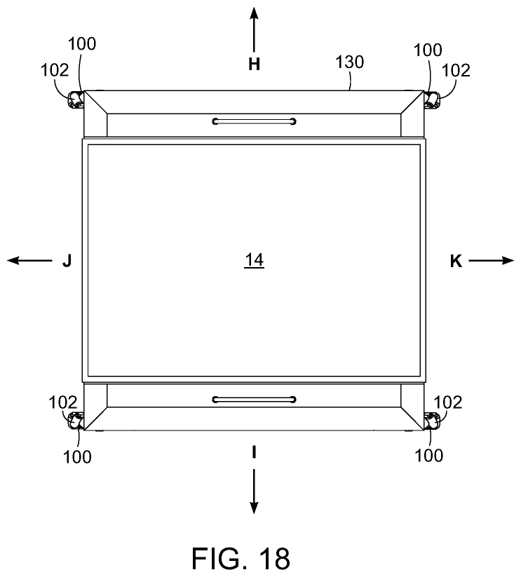

In other embodiments, each wheel may instead be a controllable omnidirectional wheel 100, such as the Mecanum wheels sold by Mecanum AB of Sweden. With reference to FIGS. 17, and 18, each of the automated carriers 130 may include a set of controllable omnidirectional wheels 100. Each of the wheels 100 is generally a conventional wheel with a series of controllable rollers 102 attached to the circumference of each wheel. While the wheels 100 provide movement in directions as shown at J and K in FIG. 18, actuation of the rollers 102 (e.g., with limited controlled actuation of the wheels 100) provide movement in directions as shown at H and/in FIG. 18. In accordance with another embodiment, the carrier 130 may turn by operating opposing wheels in mutually reverse directions.

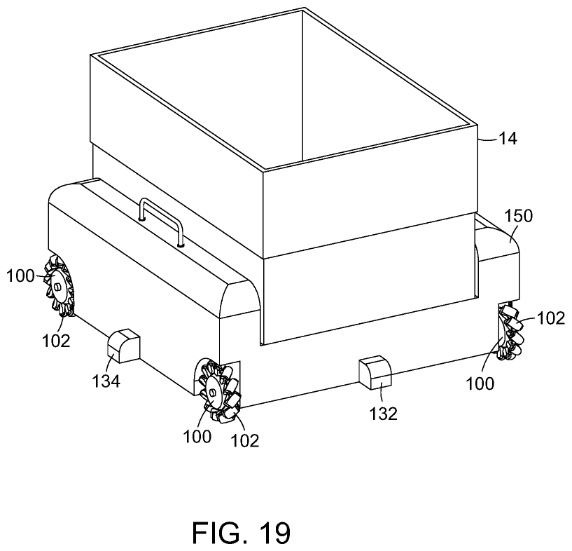

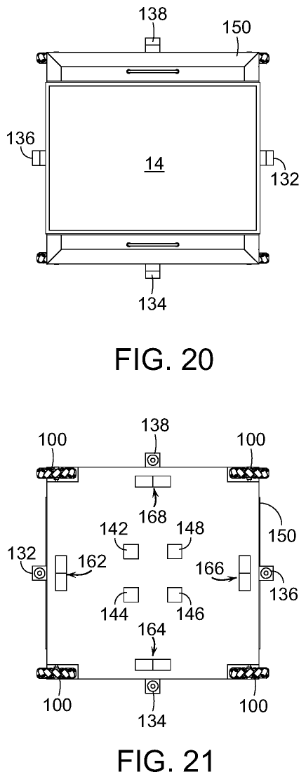

In accordance with a further embodiment, FIG. 19 shows a carrier 150 that includes four illumination sources 132, 134, 136, 138 for illuminating the track below each source. FIG. 20 shows a top view of the carrier 150, showing the position of each of the illumination sources 132, 134, 136, 138. FIG. 21 shows an underside of the carrier 150, which shows four pairs of illumination sensors 162, 164, 166, 168. As the carrier 150 moves over a track (e.g., a section of track that is under sensor pairs 162, 166), the system monitors the amount of light being received at each pair of underside sensors (e.g., each of pair 162 and each of pair 166) to determine if the amount of illumination being received by each of the pair is generally the same. If much more illumination is received by one of a pair, the system may assume that the carrier has run off course. Having two such pairs (e.g., 162, 166) for a painted track line, provides further robustness to the system. Additionally, sensors (or indicia) 142, 144, 146, 148 may be provided on the underside of each carrier 150 for communicating with any of indicia (or sensors) on the track. This may assist in providing further security in confirming the location of a carrier, and/or in providing turning instructions to a carrier.

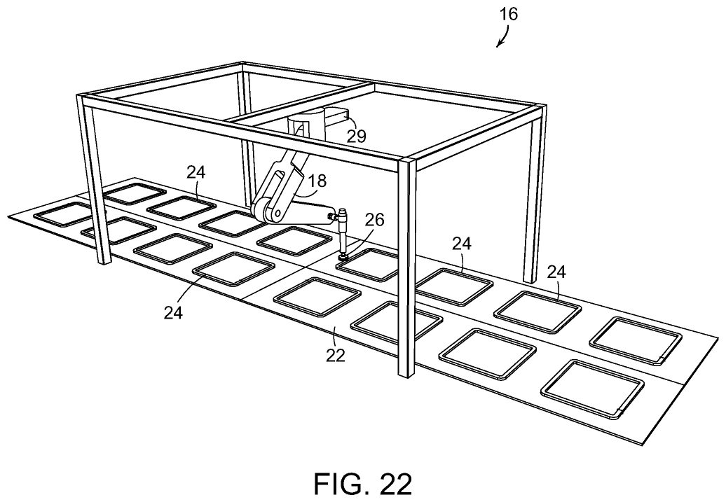

FIG. 22 shows the processing station 16, that includes the programmable motion device 18 over a track section 24 that include the discontinuous tracks 20. The system provides that at least one storage bin 12 and at least one destination bin 14 may be presented to the programmable motion device 18. The programmable motion device 18 includes an end effector 26, and the processing station 16 also includes a perception unit 29. The two bins (12, 14) may be presented underneath the programmable motion device 18 (e.g., an articulated arm) such that the end effector 26 of the device 18 may be used to grasp objects from one bin and transfer the objects to another bin under the device 18. Generally, a selected storage bin is brought to the processing station at the same time that a selected destination bin is brought to the processing station, and the programmable motion device then moves an object from the selected storage bin 12 to the selected destination bin 14. Both bins 12, 14 are then returned to empty racks, while the system maintains knowledge of the location and contents of each bin. When a destination bin is completed, the bin may be brought by a carrier to an output conveyor for further processing or shipment.

The processing station 16 also includes the perception unit 29 for providing perception data (e.g., camera images or scanning data) regarding the bins 12, 14, and in particular, regarding the contents of the storage bins 12. Since the system places the bins 12, 14 at the processing station, the system will know the locations of the bins. The processing system however, should determine proper grasp locations of the objects in the bin(s) 14.

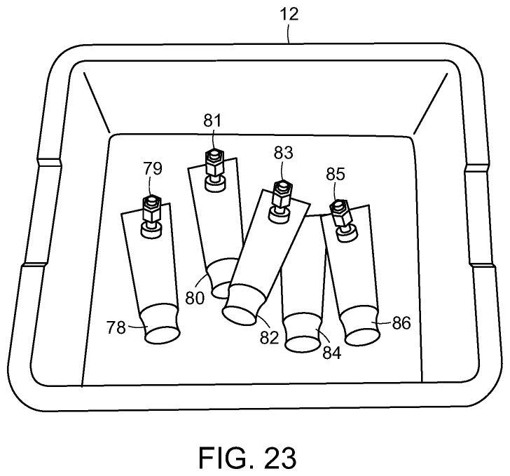

FIG. 23 shows an image view 50 of the bin 14 from the perception unit 40. The image view shows the bin 12, and the bin 12 contains objects 78, 80, 82, 84 and 86. In the present embodiment, the objects are homogenous, and are intended for distribution to different distribution packages. Superimposed on the objects 78, 80, 82, 84, 86 (for illustrative purposes) are anticipated grasp locations 79, 81, 83 and 85 of the objects. Note that while candidate grasp locations 79, 83 and 85 appear to be good grasp locations, grasp location 81 does not because its associated object is at least partially underneath another object. The system may also not even try to yet identify a grasp location for the object 84 because the object 84 is too obscured by other objects. Candidate grasp locations may be indicated using a 3D model of the robot end effector placed in the location where the actual end effector would go to use as a grasp location as shown in FIG. 23. Grasp locations may be considered good, for example, if they are close to the center of mass of the object to provide greater stability during grasp and transport, and/or if they avoid places on an object such as caps, seams etc. where a good vacuum seal might not be available.

If an object cannot be fully perceived by the detection system, the perception system considers the object to be two different objects, and may propose more than one candidate grasps of such two different objects. If the system executes a grasp at either of these bad grasp locations, it will either fail to acquire the object due to a bad grasp point where a vacuum seal will not occur, or will acquire the object at a grasp location that is very far from the center of mass of the object and thereby induce a great deal of instability during any attempted transport. Each of these results is undesirable.

If a bad grasp location is experienced, the system may remember that location for the associated object. By identifying good and bad grasp locations, a correlation is established between features in the 2D/3D images and the idea of good or bad grasp locations. Using this data and these correlations as input to machine learning algorithms, the system may eventually learn, for each image presented to it, where to best grasp an object, and where to avoid grasping an object.

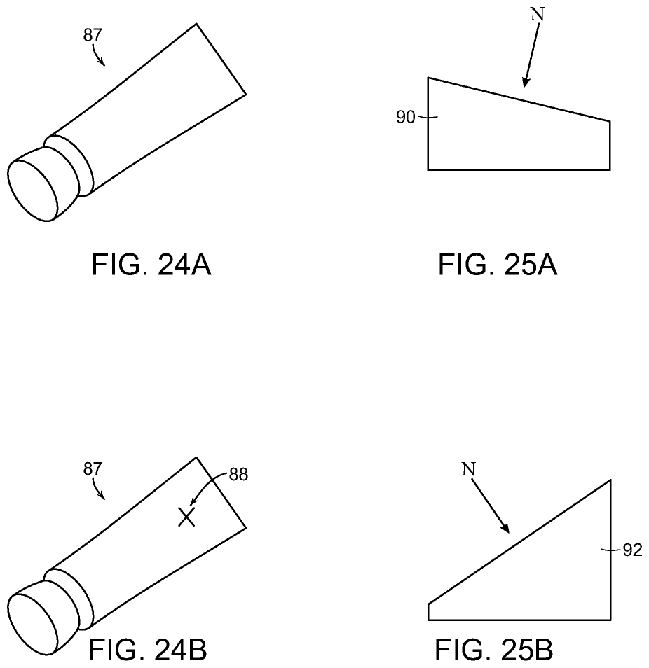

As shown in FIGS. 24A and 24B, the perception system may also identify portions of an object that are the most flat in the generation of good grasp location information. In particular, if an object includes a tubular end and a flat end such as object 87, the system would identify the more flat end as shown at 88 in FIG. 24B. Additionally, the system may select the area of an object where a UPC code appears, as such codes are often printed on a relatively flat portion of the object to facilitate scanning of the barcode.

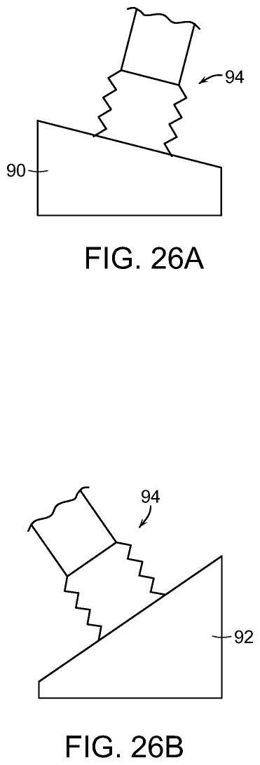

FIGS. 25A and 25B show that for each object 90, 92, the grasp selection system may determine a direction N that is normal to the selected flat portion of the object 90, 92. As shown in FIGS. 26A and 26B, the robotic system will then direct the end effector 94 to approach each object 90, 92 from the direction that is normal to the surface in order to better facilitate the generation of a good grasp on each object. By approaching each object from a direction that is substantially normal to a surface of the object, the robotic system significantly improves the likelihood of obtaining a good grasp of the object, particularly when a vacuum end effector is employed.

The invention provides therefore in certain embodiments that grasp optimization may be based on determination of surface normal, i.e., moving the end effector to be normal to the perceived surface of the object (as opposed to vertical or gantry picks), and that such grasp points may be chosen using fiducial features as grasp points, such as picking on a barcode, given that barcodes are almost always applied to a flat spot on the object.

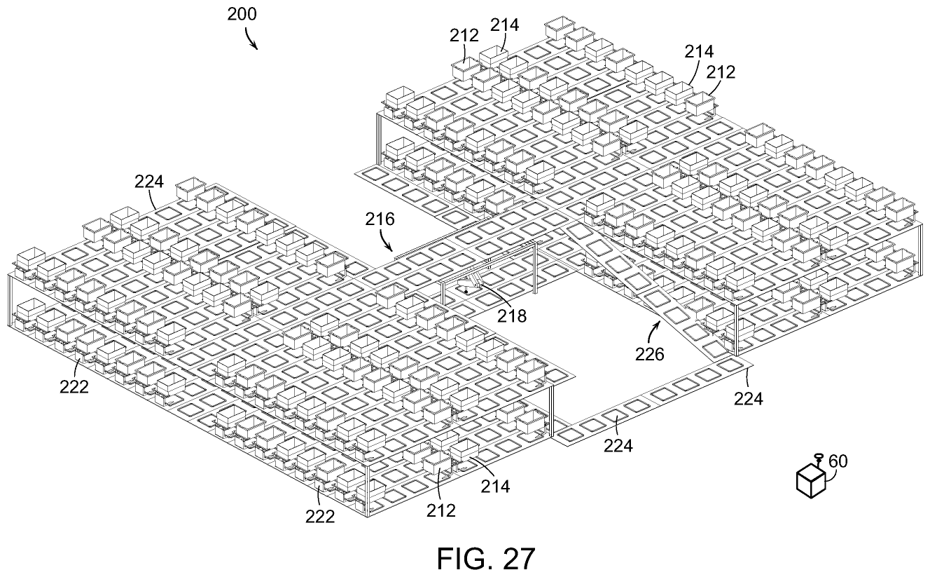

With reference to FIG. 27, in accordance with a further embodiment, the invention provides a system 200 that includes a plurality of storage bins 212, a plurality of destination bins 214, and a processing section 216 that includes a programmable motion device 218. The bins 212, 214 are located on shelves 222 that are positioned on track sections 224 as discussed above, but the track sections 224 are provided as two levels of track sections with shelves and bins on both levels. The track sections 224 include ramps 226 that permit the bins to be delivered to and from any of the shelves 220 on either level.

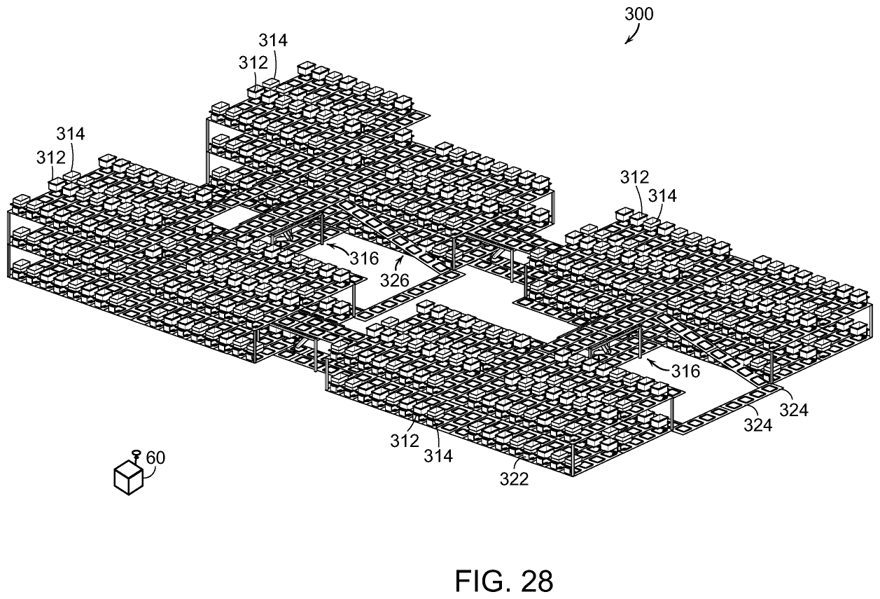

With reference to FIG. 28, in accordance with a further embodiment, the invention provides a system 300 that includes a plurality of storage bins 312, a plurality of destination bins 314, and a plurality of processing sections 316 that each includes a programmable motion device 318. The bins 312, 314 are located on shelves 322 that are positioned on track sections 324 again as discussed above, but the track sections 324 are provided as many levels of track sections with shelves and bins on both levels. The track sections 324 include ramps 326 that permit the bins to be delivered to and from any of the shelves 320 on any level.

Again, the system is programmed to retrieve objects from the selected storage bin(s), and provide them to destination bins in accordance with a manifest. Following processing, the returned storage bin(s) may be returned anywhere in the storage section as long as the system knows where each bin has been returned, and the returned destination bin(s) may be returned anywhere in the storage section as long as the system knows where each bin has been returned.

Control of each of the systems may be provided by the computer system 60 that is in communication with the programmable motion devices as well as the carriers. The computer system 60 also contains the knowledge (continuously updated) of the location and identity of each of the storage bins, and contains the knowledge (also continuously updated) of the location and identity of each of the destination bins. The system therefore, directs the movement of the storage bins and the destination bins, and retrieves objects from the storage bins, and distributes the objects to the destination bins in accordance with an overall manifest that dictates which objects must be provided in which destination boxes for shipment, for example, to distribution or retail locations.

In the systems of the present invention, throughput and storage may scale independently, and all inventory SKUs may reach all outbound containers. The systems are robust to failures due to redundancy, and inventory totes (storage bins) and outbound boxes (destination bins) may be handled interchangeably.

Those skilled in the art will appreciate that numerous modifications and variations may be made to the above disclosed embodiments without departing from the spirit and scope of the present invention.

What is claimed is:

1.-27. (canceled)

28. An object processing system comprising:
a plurality of processing bins, one or more of the plurality of processing bins containing objects to be processed;
a plurality of automated mobile carts, each automated mobile cart including a transport area that is adapted to receive and transport any of the plurality of processing bins on a plurality of stands on which any of the plurality of processing bins may be supported, and at least two wheels that provide movement of each automated mobile cart in a first direction and in a second direction that is orthogonal to the first direction, each automated mobile cart providing that an orientation of its respective transport area may remain unchanged when the automated mobile cart changes direction between the first direction and the second direction;
a plurality of shelves within the automated mobile cart transport area, each of the plurality of shelves including a plurality of prongs onto which any of the plurality of processing bins is placed or removed by the plurality of automated mobile carts, each of the plurality of automated mobile carts being adapted to place any of the plurality of processing bins onto a placement designated shelf of the plurality of shelves;
a bin processing area within the automated mobile cart transport area at which a selected processing bin of the plurality of processing bins is provided on a selected automated mobile cart of the plurality of automated mobile carts; and
a programmable motion device proximate the bin processing area, said programmable motion device including an end-effector for grasping a selected object from the selected processing bin at the bin processing area and for moving the selected object to a processing location.

29. The object processing system of claim 28, wherein the processing location is a destination processing bin of the plurality of processing bins.

30. The object processing system of claim 28, wherein the plurality of processing bins includes storage bins and destination bins, and wherein the storage bins are totes and the destination bins are boxes for shipping and transport.

31. The object processing system of claim 30, wherein the storage bins and the destination bins are intermingled among the plurality of shelves.

32. The object processing system of claim 28, wherein when the plurality of stands on the placement automated mobile cart of the plurality of automated mobile carts are moved among the plurality of prongs on the placement designated shelf, the plurality of stands on the placement automated mobile cart alternate with the plurality of prongs on the placement designated shelf.

33. The object processing system of claim 28, wherein when the plurality of stands on the retrieval automated mobile cart of the plurality of automated mobile carts are moved among the plurality of prongs on the retrieval designated shelf, the plurality of stands on the retrieval automated mobile cart alternate with the plurality of prongs on the retrieval designated shelf.

34. The object processing system of claim 28, wherein the plurality of shelves are provided on a plurality of vertical levels.

35. The object processing system of claim 34, wherein the object processing system includes at least one ramp connecting the plurality of vertical levels and wherein the plurality of automated mobile carts are movable along the at least one ramp to access each of the plurality of vertical levels.

36. An object processing system comprising:
a plurality of processing bins, one or more of the plurality of processing bins containing objects to be processed;
a plurality of automated mobile carts, each automated mobile cart including a transport area that is adapted to receive and transport any of the plurality of processing bins on a plurality of stands on which any of the plurality of processing bins may be supported, and at least two wheels that provide movement of each automated mobile cart in a first direction and in a second direction that is orthogonal to the first direction, each automated mobile cart providing that an engagement orientation of its respective transport area may remain unchanged when the automated mobile cart changes direction between the first direction and the second direction;
a plurality of shelves within the automated mobile cart transport area, each of the plurality of shelves including a plurality of prongs onto which any of the plurality of processing bins is placed or removed by the plurality of automated mobile carts, each of the plurality of automated mobile carts being adapted to place any of the plurality of processing bins onto a placement designated shelf of the plurality of shelves when the transport area of each automated mobile cart is in the engagement orientation; and
a bin processing area within the automated mobile cart transport area at which a selected processing bin of the plurality of processing bins is provided on a selected automated mobile cart of the plurality of automated mobile carts.

37. The object processing system of claim 36, wherein the processing location is a destination processing bin of the plurality of processing bins.

38. The object processing system of claim 36, wherein the plurality of processing bins includes storage bins and destination bins, and wherein the storage bins are totes and the destination bins are boxes for shipping and transport.

39. The object processing system of claim 38, wherein the storage bins and the destination bins are intermingled among the plurality of shelves.

40. The object processing system of claim 36, wherein when the plurality of stands on the placement automated mobile cart of the plurality of automated mobile carts are moved among the plurality of prongs on the placement designated shelf, the plurality of stands on the placement automated mobile cart alternate with the plurality of prongs on the placement designated shelf.

41. The object processing system of claim 36, wherein when the plurality of stands on the retrieval automated mobile cart of the plurality of automated mobile carts are moved among the plurality of prongs on the retrieval designated shelf, the plurality of stands on the retrieval automated mobile cart alternate with the plurality of prongs on the retrieval designated shelf.

42. The object processing system of claim 36, wherein the plurality of shelves are provided on a plurality of vertical levels.

43. The object processing system of claim 42, wherein the object processing system includes at least one ramp connecting the plurality of vertical levels and wherein the plurality of automated mobile carts are movable along the at least one ramp to access each of the plurality of vertical levels.

44. A method of processing objects, said method comprising:
providing a plurality of processing bins, one or more of the plurality of processing bins containing objects to be processed;
moving a plurality of automated mobile carts within an automated mobile cart transport area, each of the plurality of automated mobile carts including a plurality of stands on which any of the plurality of processing bins is supported, and each of the automated mobile carts being adapted to receive and transport any of the plurality of processing bins, and at least two wheels that provide movement of each automated mobile cart in a first direction and in a second direction that is orthogonal to the first direction, each automated mobile cart providing that an engagement orientation of its respective transport area may remain unchanged when the automated mobile cart changes direction between the first direction and the second direction;
providing a plurality of shelves within the automated mobile cart transport area, each of the plurality of shelves including a plurality of prongs onto which any of the plurality of processing bins is placed or removed by the plurality of automated mobile carts when the transport area of each automated mobile cart is in the engagement orientation;
moving a selected processing bin to a bin processing area that is proximate a programmable motion device; and
using an end-effector of the programmable motion device to grasp an object in the selected processing bin and to move the object to a processing location.

45. The method of claim 44, wherein the processing location is a destination processing bin of the plurality of processing bins.

46. The method of claim 44, wherein the plurality of processing bins includes storage bins and destination bins, and wherein the storage bins are totes and the destination bins are boxes for shipping and transport.

47. The method of claim 46, wherein the storage bins and the destination bins are intermingled among the plurality of shelves.

48. The method of claim 44, wherein when the plurality of stands on the retrieval automated mobile cart of the plurality of automated mobile carts are moved among the plurality of prongs on the retrieval designated shelf, the plurality of stands on the retrieval automated mobile cart alternate with the plurality of prongs on the retrieval designated shelf.

49. The method of claim 44, wherein the method further includes:
moving a placement automated mobile cart to a placement designated shelf of the plurality of shelves, the placement automated mobile cart including thereon a placement processing bin of the plurality of processing bins; and
moving the plurality of stands on the placement automated mobile cart among the plurality of prongs on the placement designated shelf to facilitate transfer of the placement processing bin to the placement designated shelf.

50. The method of claim 49, wherein when the plurality of stands on the placement automated mobile cart of the plurality of automated mobile carts are moved among the plurality of prongs on the placement designated shelf, the plurality of stands on the placement automated mobile cart alternate with the plurality of prongs on the placement designated shelf.

51. The method of claim 44, wherein the plurality of shelves are provided on a plurality of vertical levels.

52. The method of claim 44, wherein the method includes moving the plurality of automated mobile carts among the plurality of vertical levels using at least one ramp connecting the plurality of vertical levels.
